(19) United States
(12) Patent Application Publication
(10) Pub. No.: US 2009/0162056 A1
(43) Pub. Date: Jun. 25, 2009

(54) METHOD AND APPARATUS FOR MEASURING SIGNAL POWER LEVELS USING AN OPTICAL NETWORK TERMINATOR AND A SET TOP BOX

(75) Inventor: Guy M. Merritt, Purcellville, VA (US)

Correspondence Address: FITZPATRICK CELLA HARPER & SCINTO, 30 ROCKEFELLER PLAZA, NEW YORK, NY, 10112, US

(73) Assignee: TELLABS VIENNA, INC., Naperville, IL (US)

(21) Appl. No.: 11/960,690

(22) Filed: Dec. 19, 2007

(51) Int. Cl. H04B 17/00

(52) U.S. Cl. 398/38

(57) ABSTRACT

Methods, systems, apparatuses, and computer programs for measuring power levels of media signals in a communications network such as, for example, an FTTx network, using an Optical Network Terminal (ONT) and a Set Top Box (STB). A method for detecting a signal power level of a channel in a communication network includes (1) selecting a channel to be measured, and a corresponding node and user terminal communicatively coupled thereto, on the network, (2) detecting a signal power level of the selected channel at the corresponding node, (3) detecting a signal power level of the selected channel at the corresponding user terminal, (4) performing a comparison involving the detected signal power levels, and (5) providing a notification of a result of performing the comparison if the result exceeds a predetermined threshold.

### BACKGROUND

1. Field

Example aspects of this invention relate in general to communication systems, and more particularly to improved methods, systems, apparatuses, and programs for measuring power levels of media signals (voice, data, and/or video) using an optical network terminal (ONT) and a set top box (STB).

2. Related Art

There is a growing demand in the communications industry to find a solution to transmit voice, data, or video from a headend to a subscriber's premises, through a fiber optic network and all the way into an individual home or business. Such fiber optic networks generally are referred to as fiber-to-the-home (FTTH), fiber-to-the-premises (FTTP), fiber-to-the-business (FTTB), fiber-to-the-node (FTTN), or fiber-to-the-curb (FTTC) networks and the like, depending on the specific application of interest. Such types of networks are also referred to herein generally as “FTTx networks”.

Passive Optical Networks (PON) are an emerging broadband, multi-services access technology allowing the benefits of fiber optic transmission to be pushed closer to the customer, including directly to the customer location. A PON is a point-to-multipoint, FTTP network architecture which enables two-way traffic on a single fiber optic cable. Installation costs are reduced by allowing an optical transceiver at the network end of the access system to be shared with many customers and minimizing the number of trunk/feeder fibers toward the customer premises. Operation costs are reduced by the passive nature of the optical distribution network. Such a passive optical network can be utilized to deliver a multitude of media services into the home, such as voice, video, and data services. Delivery of such services can take on a variety of forms after conversion from the Optical Network Terminal (ONT), including but not limited to a radio frequency (RF) signal utilized over coaxial cable.

Service providers typically measure the power level of an RF signal once it has emerged from the ONT to ensure customer satisfaction and to reduce trouble reports post installation. An example of a known approach to measuring the RF power levels for a typical RF overlay application is to individually check the RF power levels for each channel by taking a manual measurement for each channel using a portable, dedicated measuring device on the coaxial cable at two locations: near the ONT and near the Set Top Box (STB) of a particular customer. This involves gaining access to the STB of each customer whose signal must be diagnosed. It can also be extremely time consuming and, in many installations, the check of the RF power levels for every channel is rarely completed.

Furthermore, an ONT is typically only capable of taking a wideband RF power average, which can be very imprecise and cannot measure the power of an individual channel.

Moreover, with manual RF power level measurements at each STB, generally a problem is not detected until the RF power level degradation is visible to the customer and the customer reports this to the service provider, as service providers rarely perform in-home preventative maintenance checks due to scheduling and cost concerns.

### SUMMARY

Example aspects of the invention include methods, systems, apparatuses, and programs for measuring power levels of media signals in a communications network such as, for example, an FTTx network (e.g., FTTH, FTTP, FTTB, FTTN, FTTC, etc.), using an Optical Network Terminal (ONT) and a Set Top Box (STB).

The term “media signals” as used herein includes, for example, at least one of voice, video, and data signals, such as but not limited to RF signals utilized over a coaxial cable, including those converted at an ONT.

According to an example aspect of the invention, a method for detecting a signal power level of a channel in a communication network includes (1) selecting a channel to be measured, and a corresponding node and user terminal communicatively coupled thereto, on the network, (2) detecting a signal power level of the selected channel at the corresponding node, (3) detecting a signal power level of the selected channel at the corresponding user terminal, (4) performing a comparison involving the detected signal power levels, and (5) providing a notification of a result of performing the comparison if the result exceeds a predetermined threshold.

Further features and advantages, as well as the structure and operation, of various example embodiments of this invention are described in detail below with reference to the accompanying drawings.

### BRIEF DESCRIPTION OF THE DRAWINGS

The features and advantages of the example embodiments of the invention presented herein will become more apparent from the detailed description set forth below when taken in conjunction with the drawings in which like reference numbers indicate identical or functionally similar elements.

FIG. 1 illustrates a physical hardware implementation implementing a passive optical network, according to an example embodiment of the invention.

FIG. 2 is a flow diagram that illustrates a method for measuring power levels of media signals in a communication network, in accordance with an example embodiment of the invention.

FIG. 3 shows a block diagram of the functional components of an example embodiment of the invention within an Optical Network Terminal (ONT).

FIG. 4 shows a block diagram of the functional components of an example embodiment of the present invention within a Set Top Box (STB).

FIG. 5 illustrates a typical FTTx network.

FIG. 6 is an architecture diagram of a data processing system or device according to an example embodiment of the invention.

FIG. 7 is a logical diagram of modules in accordance with an example embodiment of the invention.

Example embodiments of the present invention will next be described; however, it should be clear to those skilled in the art that various modifications, additions, and subtractions can be made without departing from the spirit or scope of the claims.

### DETAILED DESCRIPTION

Example aspects of the invention include methods, systems, apparatuses, and programs for measuring RF power levels for analog and digital television channels on a PON that can be performed quickly, efficiently, and cost effectively while not necessarily requiring technician presence in the end user's place of consumption.

In one example aspect of the invention, there are provided methods, systems, apparatuses, and programs for measuring RF power levels for analog and digital television channels using, for example, an ONT and a STB, or at any suitable location in the network. Measurements can be made substantially without disrupting or detrimentally affecting the signal because they can be taken on a live network.

In a typical FTTx network, equipment at a headend or central office couples the FTTx to external services such as a Public Switched Telephone Network (PSTN) or an external network. Signals received from these services are converted into optical signals and are combined onto a single optical fiber at a plurality of wavelengths, with each wavelength defining a channel within the FTTx network.

In a FTTP network, the optical signals are transmitted through the FTTP network to an optical splitter that splits the optical signals and transmits the individual optical signals over a single optical fiber to a subscriber's premises. At the subscriber's premises, the optical signals are converted into electrical signals using an Optical Network Terminal (ONT). The ONT may split the resultant signals into separate services required by the subscriber such as computer networking (data), telephony and video. In FTTC and FTTN networks, the optical signal is converted to an electrical signal by either an Optical Network Unit (ONU) (FTTC) or a Remote Terminal (RT) (FTTN), before being provided to a subscriber's premises.

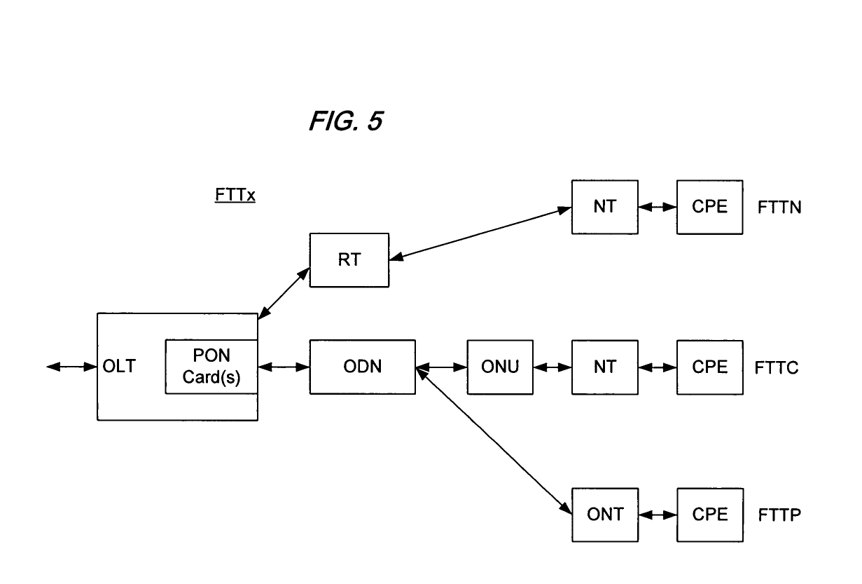

A typical FTTx network often includes one or more Optical Line Terminals (OLTs) which each include one or more Passive Optical Network (PON) cards. Such a network is illustrated in FIG. 5. Each OLT typically is communicatively coupled to one or more ONTs (in the case of a FTTP network), or to one or more Optical Network Units (ONU) (in the case of a FTTC network), via an Optical Distribution Network (ODN). In a FTTP network, the ONTs are communicatively coupled to customer premises equipment (CPE) used by end users (e.g., customers or subscribers) of network services. In a FTTC network, the ONU's are communicatively coupled to network terminals (NT), and the NTs are communicatively coupled to CPE. NTs can be, for example, digital subscriber line (DSL) modems, asynchronous DSL (ADSL) modems, very high speed DSL (VDSL) modems, or the like. In a FTTN network, each OLT typically can be communicatively coupled to one or more RTs. The RTs are communicatively coupled to NTs that are communicatively coupled to CPE.

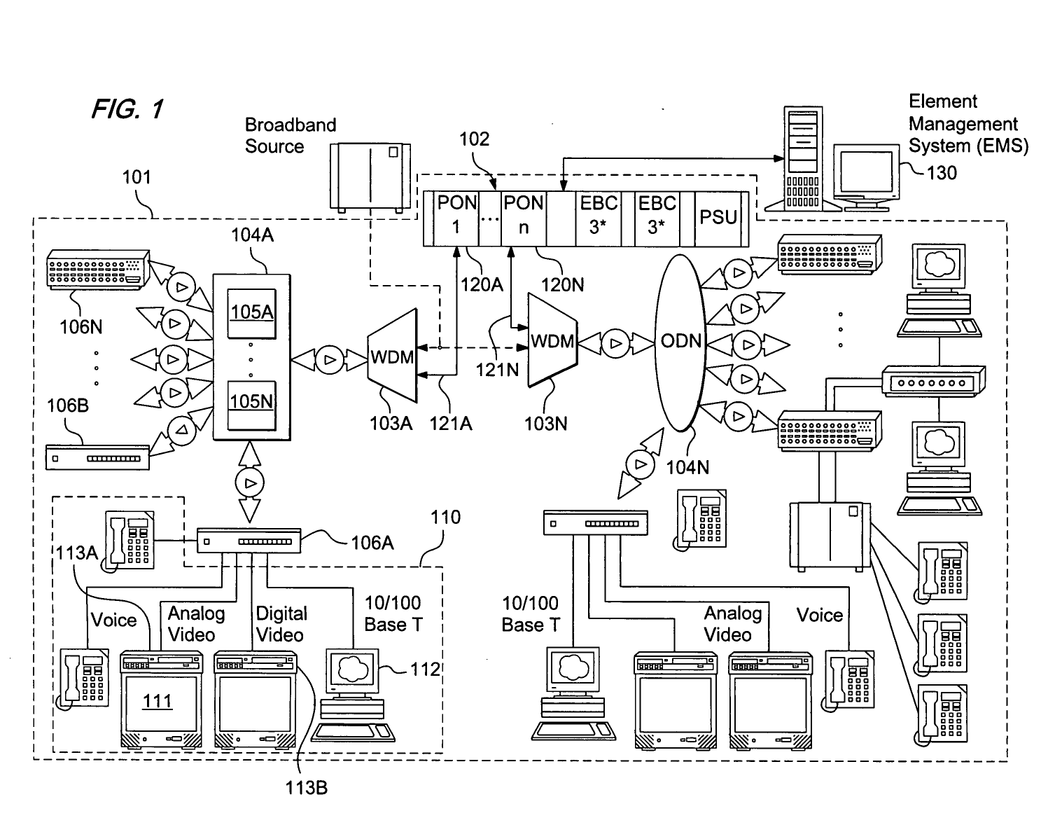

FIG. 1 is a network diagram of an example communication system or network. A Passive Optical Network (PON) 101 of the system includes an optical line terminal (OLT) 102, wavelength division multiplexers 103a-n, optical distribution network (ODN) devices 104a-n, ODN device splitters (e.g., 105a-n associated with ODN device 104a), optical network terminals (ONTs) (e.g., 106-n corresponding to ODN device splitters 105a-n), and customer premises equipment (e.g., 110). The OLT 102 includes PON cards 120a-n, each of which provides an optical feed (121a-n) to ODN devices 104a-n. Optical feed 121a, for example, is distributed through corresponding ODN device 104a by separate ODN device splitters 105a-n to respective ONTs 106a-n in order to provide communications to and from customer premises equipment 110.

The PON 101 may be deployed for fiber-to-the-business (FTTB), fiber-to-the-curb (FTTC), and fiber-to-the-home (FTTH) applications, for example. The optical feeds 121a-n in PON 101 may operate at bandwidths such as 155 Mb/sec, 622 Mb/sec, 1.25 Gb/sec, and 2.5 Gb/sec or any other desired bandwidth implementations. The PON 101 may incorporate, for example, ATM communications, broadband services such as Ethernet access and video distribution, Ethernet point-to-multipoint topologies, BPON communications, GPON communications, EPON communications, and native communications of data and time division multiplex (TDM) formats. Customer premises equipment (e.g., 110) which can receive and provide communications in the PON 101 may include standard telephones (e.g., Public Switched Telephone Network (PSTN)), Internet Protocol telephones, Ethernet units, and video devices (e.g., 111), computer terminals (e.g., 112), as well as any other type of customer premise equipment, such as Set Top Boxes (STBs) 113a or 113b.

PON 101 can include one or more different types of ONTs (e.g., 106a-n). Each ONT 106a-n, for example, communicates with an ODN device 104a through associated ODN device splitters 105a-n. Each ODN device 104a-n in turn communicates with an associated PON card 120a-n through respective wavelength division multiplexers 103a-n. Wavelength division multiplexers 103a-n are optional components which are used when video services are provided. Communications between the ODN devices 104a-n and the OLT 102 occur over a downstream wavelength and an upstream wavelength. The downstream communications from the OLT 102 to the ODN devices 104a-n may be provided at, for example, 622 megabytes per second, which is shared across all ONTs connected to the ODN devices 104a-n. The upstream communications from the ODN devices 104a-n to the PON cards 120a-n may be provided at, for example, 155 megabytes per second, which is shared among all ONTs connected to ODN devices 104a-n, although the system and method is not limited to those specific types of downstream and upstream communications only, and may also include the types of example communications referred to above or any other suitable types of communications.

FIG. 1 further illustrates the OLT 102 managed by an Element Management System (EMS) 130. Since the OLT 102 includes the PON cards 120a-n, each PON card 120a-n is also managed by the EMS 130. As such, a single EMS manages all PON cards within a PON. A single EMS, however, may manage or otherwise be associated with more than one PON. As such, a single EMS is not limited to managing PON cards within a single PON, but may manage PON cards from several PONs. In other example aspects of the invention, more than one EMS can be employed to manage one or more PON cards within a single PON or plural PONs.

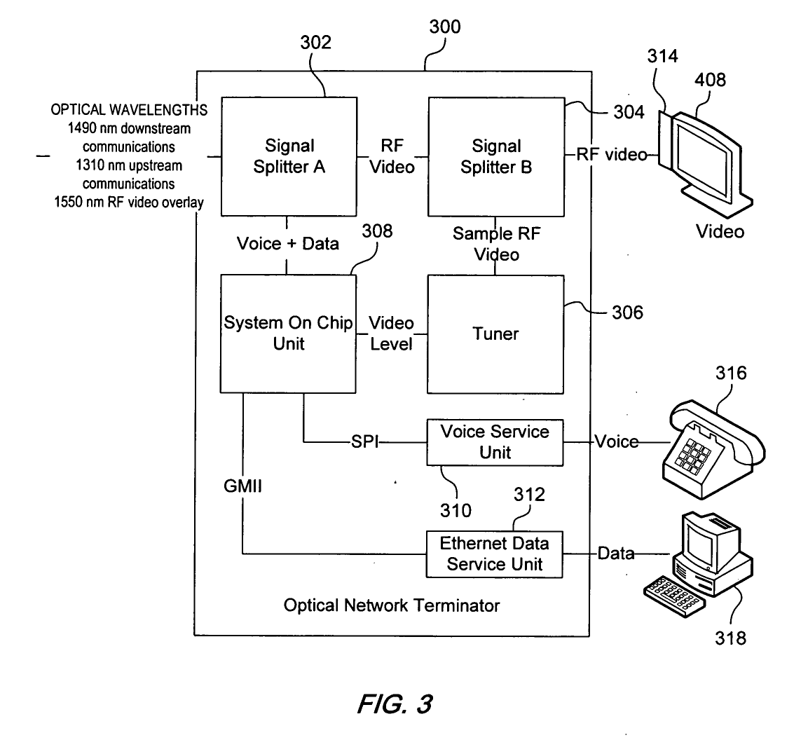

FIG. 3 shows a high level block diagram representation of an example embodiment of the invention within an Optical Network Terminal (ONT) 300, such as the ONTs 106a-n shown in FIG. 1. Media data is transmitted from head end equipment from, for example, a Video Hub Office (VHO) to a PON (such as PON 101 of FIG. 1), and travels through the PON 101 in an optical wavelength (at, e.g., 1550 nm) to an ONT 300. The optical signal is used to transport television channels in both analog and digital formats in the RF spectrum (e.g., from 50 Mhz to 870 Mhz); typically 256 quadrature amplitude modulation (QAM) is used for modulating the digital channels. The optical power level that arrives at the ONT 300 is typically between approximately −6 dbmv and −12 dbmv.

The ONT 300 has a device, signal splitter A 302, that converts the optical signal received to a voice signal, a data signal, and/or an electrical RF signal that is carrying the television channels. In an example embodiment, the signal splitter A 302 is a triplexer capable of splitting a signal (e.g., an optical signal) into at least three parts, using technology well known in the art; of course, this is merely an example.

The voice signal propagates to the voice service unit 310 in the ONT 300 by way of system on chip unit 308 and is exported to user voice units (e.g., 316). Such propagation may utilize any suitable protocol well known in the art, such as, for example, Serial Peripheral Interface (SPI). Moreover, such a voice unit 316 may include any device capable of communicating via traditional phone lines, including but not limited to a telephone set, a fax machine, a personal computer modem, etc. The voice service unit 310 provides a physical interface for supporting voice service, and converts a digital voice signal coming from the system on chip unit 308 to an analog voice signal that is supplied to a telephone device (e.g., 316). Conversely, the voice service unit 310 converts an analog voice signal received from a telephone device (e.g, 316) to a digital voice signal which is then supplied to the system on chip unit 308.

Likewise, the data signal propagates through system on chip unit 308 to the ethernet data service unit 312 and is exported to user data units 318. Such propagation may utilize any suitable protocol well known in the art, such as Gigabit Media Independent Interface (GMII). Moreover, such a data unit 318 may include any device capable of utilizing a data stream, including but not limited to a personal computer ethernet card, a wireless router, an ethernet bridge or hub, PDA, etc. Ethernet data service unit 312 provides a physical interface to support ethernet data services, and converts a digital data signal coming from the system on chip unit 308 to an ethernet signal that is supplied to Ethernet-based devices (e.g., 318) such as, for example, home routers, personal computers, etc. Conversely, ethernet data service unit 312 converts an ethernet signal received from an ethernet-based device (e.g., 318) to a digital data signal which is then supplied to the system on chip unit 308.

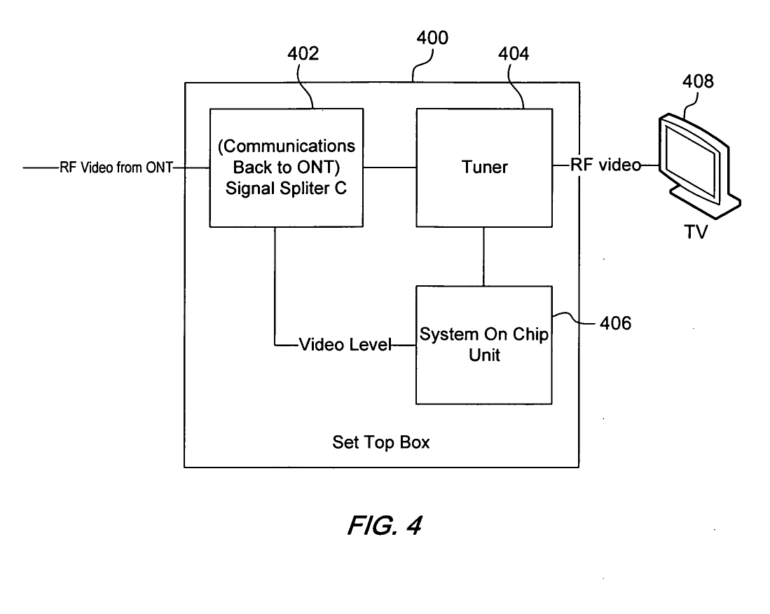

The electrical RF signal typically has a power level at an average of 18 dmv+/−3 dbmv; however, field experience has shown that individual RF channels can vary by up to approximately 8 db when compared against each other. The electical RF power signal is fed from the signal splitter A 302 into signal splitter B 304. In an example embodiment, signal splitter B 304 is a diplexer capable of splitting an optical signal into at least two parts using technology well known in the art. Signal splitter B 304 splits the electrical RF power signal into multiple signals, sending one signal out to the home video unit 314 and sending one to the tuner 306. In an example embodiment, the home video unit 314 is the STB 400 of FIG. 4, or another suitable type of video unit.

The tuner 306 tunes the electrical RF signal to a specific channel (or channels). Many different types of tuners can be used, with an example aspect of the invention utilizing an Analog and QAM Tuner based on a traditional silicon tuner chip. The specific channel is then sent to the system on chip unit 308.

The system on chip unit 308 carries out many of the higher level functions of the ONT device, such as processing of incoming data, storing of variables, and management of communications and signal flows. The system on chip unit 308 measures the RF power level of the single channel signal (or plural selected channels) sent from the tuner 306 using measurement techniques known in the art, and stores the measured value locally at the ONT. This measurement is retained for a later comparison, as further explained herein.

FIG. 4 shows a high level block diagram representation of an example Set Top Box (STB) 400, such as STB 113a or 113b shown in FIG. 1 or the home video unit 314 of FIG. 3. RF video enters the STB 400 from the ONT (such as ONT 106a-n of FIG. 1 or ONT 300 of FIG. 3). The RF video signal passes through the signal splitter C 402 and is fed to the tuner 404. In an example aspect of the invention, the signal splitter C is a diplexer capable of splitting an optical signal into at least two parts using technology well known in the art. The tuner 404 may be of any type known in the art, for example an analog and QAM tuner made of a typical silicon chip. Moreover, while the tuner 404 has a similar function to that of the tuner 306, it is of course to be understood that the two tuners 404 and 306 may be implemented utilizing different techniques or circuitry. Also, while in the example embodiments shown in FIGS. 3 and 4 the signal splitter C 402 has a similar function to both the signal splitter A 302 and to the signal splitter B 304, it is of course to be understood that the individual component may be implemented utilizing different techniques or circuitry.

The tuner 404 selects a particular channel (or channels) of the RF video signal, as described below, and splits that channel-specific video signal (i.e., the particular channel selected) and provides part to the end user video device 408, which may be, for example, a television, digital video recorder, a video cassette recorder, a personal computer, etc.

At least one other channel-specific video signal from the tuner 404 is fed to the system on chip unit 406 (which may, for example, be similar to the system on chip unit 308 in the ONT 300 shown in FIG. 3). The system on chip unit 406 measures the RF power level of the single channel signal (or channels) sent from the tuner 404. The results of the power level measurement are exported back to the ONT 300 via the signal splitter C 402. Such exportation can take on multiple forms of communications known in the art, for example via traditional ethernet communications, via a standard coaxial cable utilizing a Media Over Cable Alliance (MOCA) protocol, etc. In the example aspects shown in FIGS. 3 and 4, the results of the power level measurement are exported back to the ONT 300 (FIG. 3) (for example in a video level signal) via an RF return path into signal splitter B 304 which may support a transport technology such as MOCA. From the signal splitter B 304 the results can be supplied to the system on chip unit 308 for a comparative analysis as described herein.

The selected ONT (FIG. 3) performs a comparison involving the signal strength reading of (1) the selected RF channel(s) within the selected ONT and (2) the signal strength reading of the selected RF channel(s) within the STB (FIG. 4). Such a comparison can be undertaken in various ways as known in the art. For example, the signal strength readings can be compared against each other to indicate whether a power differential between the signals exceeds or is below a predetermined threshold, or each signal strength reading can be compared itself to a predetermined threshold, or any other desired comparison can be made. Of course, these examples are not meant to be limiting in any way.

In an example embodiment of the invention, such a comparison takes place within the system on chip unit 308 within the ONT 300 as shown in FIG. 3, or, in other embodiments, in the EMS 130 (FIG. 1) or elsewhere. This comparison result can then be, for example, communicated back to an EMS 130 (FIG. 1). Such communication may be achieved in various ways, including but not limited to a traditional ethernet-based communication or by another proprietary signal that could be developed by one versed in the art, etc.

It is then determined, for example by the EMS 130, whether the result of the comparison merits an external communication such as an alarm to be declared. This determination can be based on various criteria deemed by the service provider as notable for raising an alarm condition, or based on other predetermined criteria. For example, one such alarm condition can include (1) an RF channel (of an ONT and/or STB) exceeding/being less than a predefined tolerance from an established optimal power level (e.g., high or low RF power levels on a per channel basis), (2) a differential between the power levels detected in the STB(s) and ONT(s) exceeding and/or being below a predetermined threshold, and/or (3) any other criteria established during the initiation. Of course, these examples are not meant to be limiting in any way, and any other desired comparison can be made. For example, in other embodiments, a condition for declaring an alarm can be deemed present if one or more of the foregoing criteria (1) to (3) are determined to be present over a predetermined time period or at predetermined times.

In one embodiment, upon receipt of the RF channel power levels reported by the ONT 300 and the STB 400, the ONT 300 can perform a comparative analysis of the information received, and from this analysis, the ONT 300 can determine if an RF channel power level problem exists and can isolate the location of the problem (e.g., in the home coaxial network). The ONT 300 can perform a comparison involving the reported RF channel power levels at the ONT 300 and the STB 300 in any of the foregoing manners. In one example embodiment, since the ONT 300 has been programmed as to the acceptable limits of an RF power level for a channel (e.g., both high and low limits), if the ONT 300 level is deemed acceptable but the STB 400 level is not, then an alarm can be generated (as explained below) reporting that problem is in the coaxial network feeding that particular STB 400. Since many customer premises have multiple STBs, the ONT 300 can perform one or more comparisons based on the levels being received by all STBs and determine which leg of the coaxial network may be problematic. If, for example, the ONT 300 level is low (below a threshold), this could indicate that all STBs will also see a problematic RF power level for a particular channel. If, for example, the RF channel power levels reported by STBs to the ONT 300 levels are high (above a threshold), the ONT 300 could then notify that additional RF power level attenuation may be needed.

It is noted that the components and communication channels of FIGS. 3 and 4 are bidirectional in one example embodiment of the invention, although in others uni-directional components may be employed.

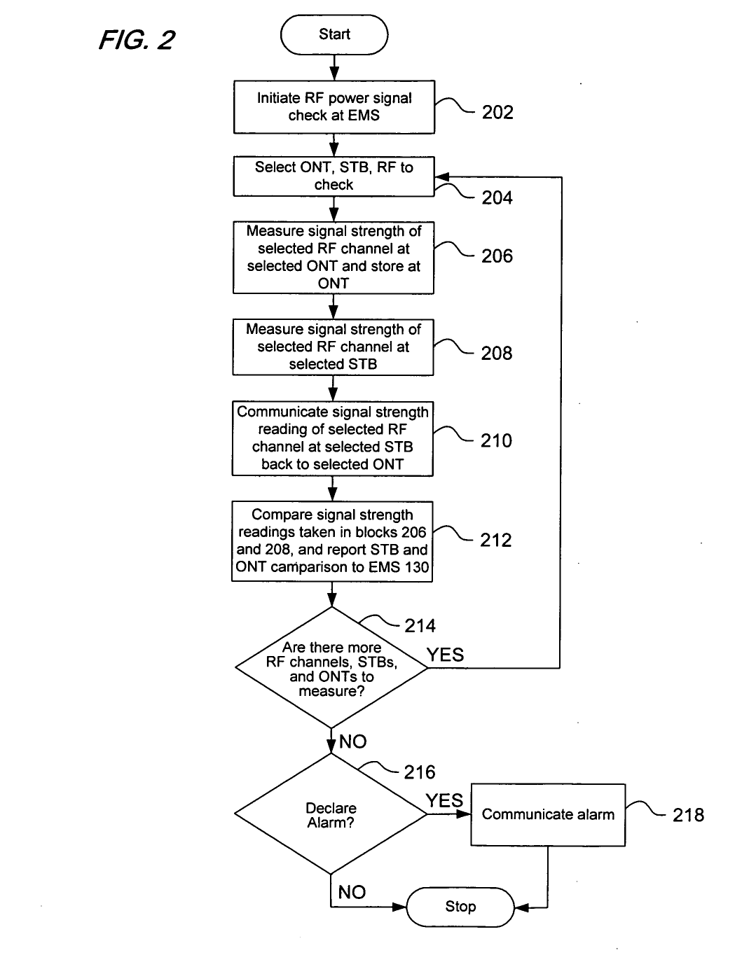

FIG. 2 is a flow diagram that illustrates a method in accordance with an example embodiment of the invention, for measuring power levels of media signals in a communications network, and in particular at an ONT and a STB. The communications network may be, for example, any FTTx network. The ONT may be, for example, ONT 106a-n of FIG. 1 or ONT 300 of FIG. 3. The STB may be, for example, STB 113a or 113b of FIG. 1 or STB 400 of FIG. 4.

In block 202 an RF power signal check is initiated. In an example aspect of the invention, this check is initiated by a scheduled process within the Element Management System (such as EMS 130 of FIG. 1) to run on provisionable intervals. Such process scheduling can be maintained and altered in various ways, for example by programming such scheduled instances directly into the EMS 130 or by remotely changing the schedule via an electronic communication with the EMS 130 such as e-mail, Short Message Service (SMS) text messaging, telnet, a proprietary signal, etc.

Utilizing a scheduled approach, a service provider can run routing diagnostics at any time including, for example, opportune times such as off-peak hours when system utilization is otherwise low (for example at 4 am). Such an automated diagnostics approach can over time build a statistical pattern representing signal power performance of the system. Such pattern can, for example, show overall decline and predict failure of a particular ONT before such a failure has actually occurred or is visible to the user. This method can thus aid in preventative maintenance by scheduling periodic tests of the overall RF overlay network, allowing service providers to detect early warning signs that a user's television signal quality is beginning to degrade. Proactive steps can then be taken by the operator to dispatch a technician prior to the homeowner even noticing a degradation in service.

In an alternative example embodiment, the RF power signal check initiated in block 202 can be effected manually by a service provider representative or technician. Such initiation can take place, for example, via a physical input into the hardware running the EMS 130 or via a remote signal into the EMS 130, such as an e-mail, a proprietary signal, a phone call, an SMS text message, etc. For example, this mode can be used by an operator or technician to troubleshoot reported video problems from a homeowner or customer, e.g., if the user were to contact the service provider after seeing a disruption in service. The results of the check, as described below, can assist the service provider and user in isolating the problem and determining whether to dispatch a technician to repair the problem.

This is notable in part because under certain regulations, the homeowner or customer is responsible for inside cabling beyond the so-called “demarcation point,” i.e., the point where the signal leaves the ONT and enters the home or customer premises. Under existing systems, the problem cannot be diagnosed until the service provider has already dispatched a technician to the user's location. Therefore, even though the user is responsible for paying for such repairs, the service provider will often not charge them for the repairs in order not to impose an unexpected fee on the customers.

Accordingly, in example embodiments of the invention, an automated process enables proactive measures to be taken, and, in other examples, a manual process can be initiated to assist in troubleshooting reported problems. Further, a check on any channel can be initiated by a technician without the need for test equipment or for physically going to every RF end point to take an actual measurement.

In block 204, a particular ONT, STB, and RF channel are selected, to check the RF power levels on. The reason for this procedure is that each Element Management System is capable of managing a plurality of ONTs on a plurality of PONs, and each ONT is capable of sending RF signals to a plurality of STBs. Moreover, contained in the RF signal between each ONT and each STB is a plurality of RF channels, each of which can have variations in signal strength. A particular ONT, STB, and RF channel (or more than one of each such items) may be selected, for example, based on a manual initiation via the EMS operator for immediate trouble shooting, or based on a preventative maintenance schedule that is initiated by an automated inspection function from the EMS 130 on pre-selected channels or on all channels, etc. Of course, these are merely examples and are not meant to be limiting in any way.

In block 206, a measurement is taken of the signal strength of the selected RF channel(s) within the selected ONT, and the signal strength value is stored locally in the ONT for later comparison, as described above in connection with FIG. 3. In block 208, a measurement is taken of the signal strength of the selected RF channel(s) within the selected STB, as described above in connection with FIG. 4.

In block 210, the STB communicates the signal strength reading of the selected RF channel(s) within the selected STB (determined in block 208) back to the selected ONT for the comparison in block 212. This communication can be accomplished in various ways, including but not limited to a conventional ethernet transmission or a Media Over Cable Alliance (MOCA) protocol utilized over the attached coaxial cable that runs to the STB from the ONT (see FIG. 3).

In block 212, the selected ONT performs one or more comparisons involving the signal strength reading of the selected RF channel(s) within the selected ONT (taken internally at block 206) and the signal strength reading of the selected RF channel(s) within the STB (taken internally at block 208). Such a comparison, the result of which is used in block 216, can be undertaken, for example, in accordance with any of the techniques described above. In an example embodiment of the invention, such a comparison takes place within the system on chip unit 308 within the ONT 300 shown in FIG. 3. This comparison result is then, for example, communicated back to an EMS 130. Such communication may be achieved in various ways, including but not limited to a traditional ethernet-based communication or by another proprietary signal that could be developed by one versed in the art, etc.

In block 214, a determination is made as to (1) whether there are more RF channels on this particular STB to measure, (2) whether there are more STBs on this particular ONT to measure, or (3) whether there are more ONTs on this particular PON to measure. In an example embodiment of the invention, this determination is carried out by the EMS 130, based on predetermined operating criteria or the like, such as whether a predetermined number of channels, STBs, and/or ONTs, have been checked, etc. If further measurements are required (“YES” block 214), then, in block 204, at least one other combination ONT/STB/RF channel can be chosen to be checked.

Accordingly, a wide variety of combinations can be checked, including every channel on the PON 101, all channels for one user experiencing problems, one problematic channel across a variety of users, etc. The results of all comparisons (e.g., the RF power levels) can be consolidated and communicated to (for example) the EMS 130, and stored therein or in any other suitable location, and displayed to the operator.

If in block 214 it is determined that no further measurements are required (“NO” at block 214), then in block 216 it is determined, for example by the EMS 130, whether the result of the comparison(s) in block 212 merits an external communication such as an alarm to be declared. This determination can be based on various criteria deemed by the service provider as notable for raising an alarm condition, such as, for example, any of the criteria (1) through (3) described above.

If an external communication is deemed appropriate (“YES” at block 216), then an alarm is declared in block 216 and in block 218, an external communication (alarm) is delivered from, e.g., the EMS, to at least one predetermined destination to signal the condition. Such communication may be of various forms, including but not limited to a warning light on the apparatus running the Element Management System 130, an e-mail concerning the details of the alarm, a paper report being generated, etc., and can be sent to the ONT(s) and/or STB(s) for which measurements were made and/or to other predetermined destinations.

If in block 216 an external communication is deemed not appropriate (“NO” of block 216), then the method will stop.

In either case, at conclusion of the method a report can be generated with information, including but not limited to the fact that a check was conducted, the ONT/STB/channel combinations checked, the date and time of the check, and the results thereof, etc. Any such report can then be outputted to a technician and/or provided to another network component.

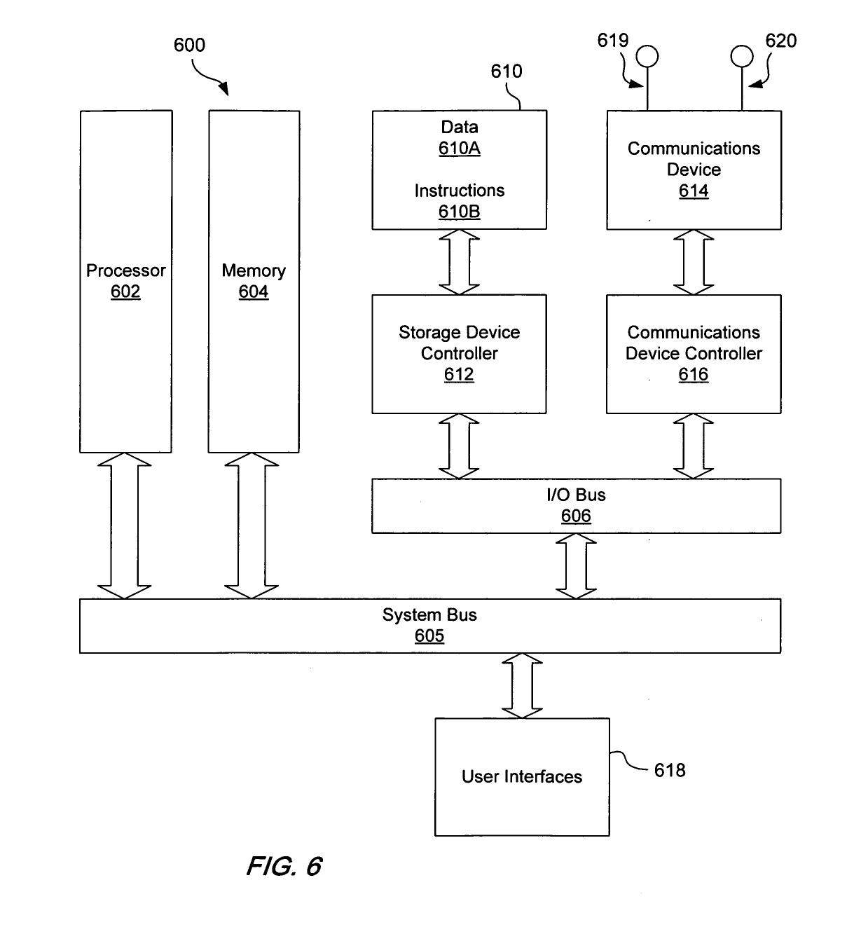

FIG. 6 is an architecture diagram of an example data processing system or device 600, which, according to an example embodiment, can form individual ones of the components ONU of FIG. 2, components 102, 104a-n, 106a-n, 110, 113a, 113b, and 130 of FIG. 1, component 300 of FIG. 3, and/or component 400 of FIG. 4. Data processing system 600 includes a processor 602 coupled to a memory 604 via system bus 606. Processor 602 is also coupled to external Input/Output (UO) devices (not shown) via the system bus 606 and an I/O bus 608, and at least one input/output user interface 618. Processor 602 may be further coupled to a communications device (interface) 614 via a communications device controller 616 coupled to the I/O bus 608. Processor 602 uses the communications device 614 to communicate with a network, such as, for example, a network as shown in FIG. 1, and the device 614 may have one or more input and output ports. In the case of at least the ONTs 106a-n, device 614 has data port 619 operably coupled to a network (e.g., PON 101) for sending and receiving data, and voice services data port 620 operably coupled to customer premises equipment (e.g., 110) for sending and receiving voice data, but device 614 may also have one or more additional input and output ports. A storage device 610 having a computer-readable medium is coupled to the processor 602 via a storage device controller 612 and the I/O bus 608 and the system bus 606. Processor 602 also can include an internal clock (not shown) to keep track of time, periodic time intervals, and the like.

The input/output user interface 618 may include, for example, at least one of a keyboard, a mouse, a trackball, touch screen, a keypad, and/or any other suitable type of user-operable input device(s), and at least one of a video display, a liquid crystal or other flat panel display, a speaker, a printer, and/or any other suitable type of output device for enabling a user to perceive outputted information.

Storage device 610 having a computer readable medium is coupled to the processor 602 via a storage device controller 612 and the I/O bus 608 and the system bus 606. The storage device 610 is used by the processor 602 and controller 612 to store and read/write data 610a, and to store program instructions 610b used to implement at least part of the procedures described herein and shown in FIG. 2. The storage device 610 also stores various routines and operating programs (e.g., Microsoft Windows, UNIX/LINUX, or OS/2) that are used by the processor 602 for controlling the overall operation of the system 600. At least one of the programs (e.g., Microsoft Winsock) stored in storage device 610 can adhere to TCP/IP protocols (i.e., includes a TCP/IP stack), for implementing a known method for connecting to the Internet or another network, and may also include web browser software, such as, for example, Microsoft Internet Explorer (IE) and/or Netscape Navigator, for enabling a user of the system 600 to navigate or otherwise exchange information with the World Wide Web (WWW).

In operation, processor 602 loads the program instructions 610b from the storage device 610 into the memory 604. Processor 602 then executes the loaded program instructions 610b to perform any of the example methods described herein, for operating the system 600 (which forms individual ones of the components 102, 104a-n, 106a-n, 110, 113a, 113b, and 130 of FIG. 1, 300 of FIG. 3, and/or 400 of FIG. 4).

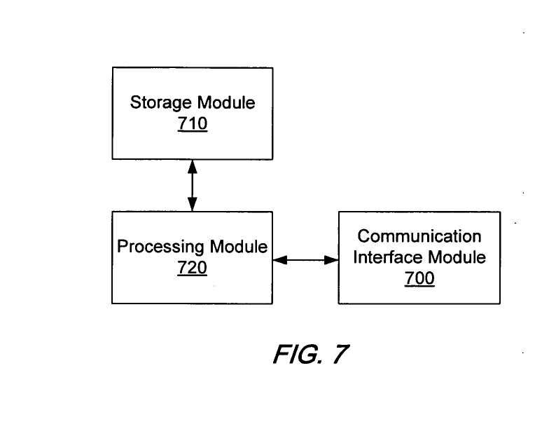

FIG. 7 is a logical diagram of modules in accordance with an example embodiment of the present invention. The modules may be of a data processing system or device 600, which, according to an example embodiment, can form individual ones of the components 102, 106a-n, 113a, 113b, and 130 of FIG. 1, components 300 of FIG. 3, 400 of FIG. 4, and/or the ONU of FIG. 5. The modules may be implemented using hardcoded computational modules or other types of circuitry, or a combination of software and circuitry modules. Communication interface module 700 controls communication device 614 by processing interface commands. Interface commands may be, for example, commands to send data, commands to communicatively couple with another device, or any other suitable type of interface command. Storage device module 710 stores and retrieves data in response to requests from processing module 720. Processing module 720 performs the procedures as described herein. For example, processing module 720 may perform a comparison in connection with FIG. 2. After performing the comparison, processing module 720 retrieves data representing the results thereof from storage module 710 and sends a response, based on that data, via communication interface module 700.

Although described in reference to a passive optical network, the same or other example embodiments of the invention may be employed in any communications network, such as an active optical network, data communications network, or wireless network (e.g., between handheld communications units and a base transceiver station). Furthermore, example embodiments of the invention may be employed in all types of passive optical networks, such as APON, BPON, GPON, WDM-PON, EPON, or any PON derivative. Example embodiments of this invention can be incorporated in networks that utilize RF overlay architectures.

Those of ordinary skill in the art should recognize that example methods of the invention may be embodied in hardware, software or firmware, a combination of hardware, software and/or firmware, or software that includes a computer usable medium. Such a computer usable medium can include, but is not limited to, a readable memory device, such as a solid state memory device, a hard drive device, a CD-ROM, a DVD-ROM, an optical disk, a magneto-optical disk, or a computer diskette, having stored computer-readable program code segments. The computer readable medium can also include a communications or transmission medium, such as a bus or a communications link, either optical, wired, or wireless, carrying program code segments as digital or analog data signals.

Software example embodiments of the present invention may be provided as a computer program product, or software, that may include an article of manufacture on a machine accessible or machine (or computer) readable medium (memory) having instructions. The instructions on the machine accessible or machine readable medium may be used to program a computer system or other electronic device. The machine-readable medium may include, but is not limited to, floppy diskettes, optical disks, CD-ROMs, and magneto-optical disks or other types of media/machine-readable medium suitable for storing or transmitting electronic instructions. The techniques described herein are not limited to any particular software configuration. They may find applicability in any computing or processing environment. The terms “machine accessible medium,” “machine readable medium,” or “computer readable medium” used herein shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

While the inventions has been particularly shown and described with respect to example embodiments thereof, it should be understood that it has been presented as such by way of example, and not limitation. It will be apparent to persons skilled in the relevant art(s) that various changes in form and detail can be made therein without departing from the spirit and scope of the invention. Thus, the example aspects of the invention should not be limited by any above-described example embodiments, but should be defined only in accordance with the following claims and their equivalents.

In addition, it should be understood that the figures illustrated in the attachments, which highlight the functionality and advantages of the present system, are presented for example purposes only. The architecture of the present system is sufficiently flexible and configurable, such that it may be utilized (and navigated) in ways other than that shown in the accompanying figures.

Furthermore, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present system in any way. It is also to be understood that the steps and processes recited in the claims need not be performed in the order presented.

What is claimed is:

1. A method for detecting a signal power level of a channel in a communication network, comprising:
selecting a channel to be measured, and a corresponding node and user terminal communicatively coupled thereto, on the network;
detecting a signal power level of the selected channel at the corresponding node;
detecting a signal power level of the selected channel at the corresponding user terminal;
performing a comparison involving the detected signal power levels; and
providing a notification of a result of performing the comparison if the result exceeds a predetermined threshold.

2. A method as set forth in claim 1, further comprising initiating the detectings at a location distinct from the node.

3. A method as set forth in claim 1, wherein the channel comprises a radio frequency (RF) signal.

4. A method as set forth in claim 1, wherein the node is an Optical Network Terminal (ONT).

5. A method as set forth in claim 1, wherein the user terminal is a Set Top Box (STB).

6. A method as set forth in claim 1, wherein the notification is provided by an Element Management System (EMS).

7. A method as set forth in claim 1, wherein the predetermined threshold is a predefined power level.

8. A method as set forth in claim 1, further comprising manually initiating the detectings.

9. A method as set forth in claim 1, further comprising automatically initiating the detectings.

10. A method as set forth in claim 1, further comprising generating a report of the result obtained in the comparing.

11. A method as set forth in claim 1, further comprising selecting at least one of a further channel, node, and user terminal for which to conduct detectings.

12. A method as set forth in claim 1, further comprising:
storing the detected signal power level of the selected channel at the corresponding node in a memory located in the node; and
communicating the signal power level of the selected channel at the corresponding user terminal to the memory located in the node.

13. A system for detecting a signal power level in a communication network, comprising:
a first detecting unit adapted to detect a signal power level of a selected channel at a corresponding node;
a second detecting unit adapted to detect a signal power level of the selected channel at a corresponding user terminal;
a processor adapted to perform a comparison involving the detected signal power levels; and
a notification unit, adapted to provide a notification of a result obtained by the processor if the result exceeds a predetermined threshold.

14. A system as set forth in claim 13, wherein the node is an Optical Network Terminal (ONT).

15. A system as set forth in claim 13, wherein the user terminal is a Set Top Box (STB).

16. A system as set forth in claim 13, wherein the notification unit is an Element Management System (EMS).

17. A computer-readable medium having stored thereon sequences of instructions, the sequences of instructions including instructions which when executed by a computer system cause the computer system to perform a method for detecting a signal power level of a channel in a communication network, comprising:
selecting a channel to be measured, and a corresponding node and user terminal communicatively coupled thereto, on the network;
detecting a signal power level of the selected channel at the corresponding node;
detecting a signal power level of the selected channel at the corresponding user terminal;
performing a comparison involving the detected signal power levels; and
providing a notification of a result of performing the comparison if the result exceeds a predetermined threshold.

18. A computer-readable medium as set forth in claim 17, wherein the channel comprises a radio frequency (RF) signal.

19. A computer-readable medium as set forth in claim 17, wherein the node is an Optical Network Terminal (ONT).

20. A computer-readable medium as set forth in claim 17, wherein the user terminal is a Set Top Box (STB).
